(19) United States
(12) Patent Application Publication
(10) Pub. No.: US 2025/0093164 A1
(43) Pub. Date: Mar. 20, 2025

(54) Foundational Models for Semantic Routing

(71) Applicant: Google LLC, Mountain View, CA (US)

(72) Inventors: Victor Carbune, Zurich (CH); Polina Zablotskaia, Berlin (DE); Matthew Sharifi, Kilchberg (CH); Manuel Tragut, Zug (CH)

(21) Appl. No.: 18/468,338

(22) Filed: Sep. 15, 2023

(51) Int. Cl. G01C 21/34; G06N 3/0455; G06N 3/084; G10L 15/06; G10L 15/18; G10L 15/183; G10L 15/30

(52) U.S. Cl. CPC G01C 21/3446; G06N 3/0455; G06N 3/084; G10L 15/063; G10L 15/1815; G10L 15/183; G10L 15/30

(57) ABSTRACT

Training data is obtained. The training data includes (a) route information indicative of a route from a starting location to a destination location, wherein the route comprises a plurality of route segments comprising a first subset of route segments and a second subset of route segments, and (b) route characteristic information descriptive of one or more route characteristics. At least the first subset of route segments and a portion of the route characteristic information associated with the first subset of route segments is processed with a machine-learned semantic routing model to obtain one or more predicted route segments for the second subset of route segments. One or more parameters of the machine-learned semantic routing model are adjusted based on an optimization function that evaluates a difference between the one or more predicted route segments and the second subset of route segments.

### FIELD

The present disclosure relates generally to semantic routing. More particularly, the present disclosure relates to foundational machine-learned models trained for semantic understanding of mapping information.

### BACKGROUND

Foundational models, such as Large Language Models (LLMs), are models with large numbers of parameters that are trained using large datasets to perform multiple tasks. Foundational models are currently revolutionizing what can be achieved with assistive AI technology in many fields, ranging from regular conversation assistants to multi-modal editing of content such as audio, images or video. Once trained, a foundational model can perform a wide variety of tasks within the context of the training data used to train the model. For example, a LLM can perform a wide variety of language tasks once trained.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining, by a computing system comprising one or more computing devices, training data comprising (a) route information indicative of a route from a starting location to a destination location, wherein the route comprises a plurality of route segments comprising a first subset of route segments and a second subset of route segments; and (b) route characteristic information descriptive of one or more route characteristics. The method includes processing, by the computing system, at least the first subset of route segments and a portion of the route characteristic information associated with the first subset of route segments with a machine-learned semantic routing model to obtain one or more predicted route segments for the second subset of route segments. The method includes adjusting, by the computing system, one or more parameters of the machine-learned semantic routing model based on an optimization function that evaluates a difference between the one or more predicted route segments and the second subset of route segments.

Another example aspect of the present disclosure is directed to a computing system, comprising one or more processor devices and a memory. The memory includes a machine-learned semantic routing model, wherein the machine-learned semantic routing model is trained to process mapping information to generate a model output comprising suggested route segments and/or information associated with route segments. The memory includes one or more tangible, non-transitory computer readable media storing computer-readable instructions that when executed by one or more processors cause the one or more processors to perform operations. The operations include obtaining, from a client computing device, one or more inputs for the machine-learned semantic routing model, wherein the one or more inputs comprises at least one of: request information indicative of a requested route segment and/or a request for mapping-related information; or route characteristic information indicative of one or more route characteristics. The operations include processing the one or more inputs to obtain a model output, wherein the model output comprises at least one of: (a) routing information indicative of a route that comprises one or more suggested route segments; or (b) semantic mapping information associated with the route. The operations include providing the model output to the client computing device.

Another example aspect of the present disclosure is directed to one or more tangible, non-transitory computer readable media storing computer-readable instructions that when executed by one or more processors cause the one or more processors to perform operations. The operations include obtaining training data including (a) route information indicative of a route from a starting location to a destination location, wherein the route comprises a plurality of route segments comprising a first subset of route segments and a second subset of route segments; and (b) route characteristic information descriptive of one or more route characteristics. The operations include processing at least the first subset of route segments and a portion of the route characteristic information associated with the first subset of route segments with a machine-learned semantic routing model to obtain one or more predicted route segments for the second subset of route segments. The operations include adjusting one or more parameters of the machine-learned semantic routing model based on an optimization function that evaluates a difference between the one or more predicted route segments and the second subset of route segments.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs training and utilization of a machine-learned semantic routing model according to some implementations of the present disclosure.

FIG. 1B depicts a block diagram of an example computing device that performs training and/or pre-training of a machine-learned semantic routing model according to some implementations of the present disclosure.

FIG. 1C depicts a block diagram of an example computing device that generates mapping information or mapping-related information with a machine-learned semantic routing model according to some implementations of the present disclosure.

FIG. 2A is a data flow diagram for performing pre-training for a machine-learned semantic routing model according to some implementations of the present disclosure.

FIG. 2B is a data flow diagram for performing a subsequent pre-training iteration for the machine-learned semantic routing model using route information different than the route information of FIG. 2A according to some implementations of the present disclosure.

FIG. 3 is a block diagram for an example machine-learned semantic routing model 300 according to some implementations of the present disclosure.

FIG. 4 depicts a flow chart diagram of an example method to perform training, and/or fine-tuning, of a machine-learned semantic routing model according to some implementations of the present disclosure.

FIG. 5 depicts a flow chart diagram of an example method to perform map-related tasks using a machine-learned semantic routing model according to some implementations of the present disclosure.

Reference numerals that are repeated across plural figures are intended to identify the same features in various implementations.

### DETAILED DESCRIPTION

### Overview

Generally, the present disclosure is directed to semantic routing. More particularly, the present disclosure relates to foundational machine-learned models trained for semantic understanding of mapping information. In particular, training data can be obtained to train a foundational mapping model, such as a machine-learned semantic routing model. The training data can include route information indicative of a route including a number of route segments (e.g., a real route previously requested and performed by a user, etc.). The training data can also include route characteristic information. The route characteristic information can be metadata associated with the route (e.g., a preferred type of route, a method of transportation, contextual information, etc.). For example, if the route indicated by the route information is a route previously provided to a user, the route characteristic information can include intermediate locations within the route, entities located along the route (e.g., businesses, Points of Interest (POIs), landmarks, etc.),

The training data can be used to train, or fine-tune, a machine-learned semantic routing model. The machine-learned semantic routing model can be a foundational model for map-related tasks (e.g., generating routes and/or route segments, semantically analyzing routes, etc.) that includes large numbers of parameters and is trained on a large corpus of training data (e.g., mapping data). To train, or fine-tune, the machine-learned semantic routing model, some of the route segments closer to the destination location of the route can be masked. The training data can be input to the machine-learned semantic routing model to obtain a model output. The model output can include predicted route segments for the route segments that are masked. An optimization function that evaluates a difference between the predicted route segments and the masked route segments can be used to adjust one or more parameters of the machine-learned semantic routing model. In such fashion, the machine-learned semantic routing model can be trained to perform multiple mapping tasks.

Aspects of the present disclosure provide a number of technical effects and benefits. As one example technical effect and benefit, implementations of the present disclosure can substantially improve the efficiency of mapping applications. In particular, conventional mapping applications are generally difficult to navigate, and provide relatively few input options for users to indicate a particular route, or a route with particular characteristics. For example, few, if any, mapping applications provide the capability for a user to request a route that traverses a scenic route along the coast. However, implementations of the present disclosure provide a foundational model that can generate routing information based on a semantic understanding of a user request. In such fashion, the semantic meaning of a user request can be fulfilled to provide more accurate and efficient routes for mapping applications.

As another example technical effect and benefit, conventional mapping applications can sometimes generate optimal routes between a starting location and an ending location, but exhibit relatively poor performance when required to adjust a route while the route is being traveled, or when generating a route for multimodal transport (e.g., a mix of public and private transportation, etc.). However, implementations of the present disclosure can predict more efficient route segments for a route that is already in progress. In turn, this can substantially reduce travel time for a user, and thus can substantially reduce the expenditure of resources required to traverse a route (e.g., energy resources for autonomous vehicles, compute resources for onboard vehicle computers, fuel resources for conventional vehicles, etc.).

With reference now to the Figures, example embodiments of the present disclosure will be discussed in further detail.

### Example Devices and Systems

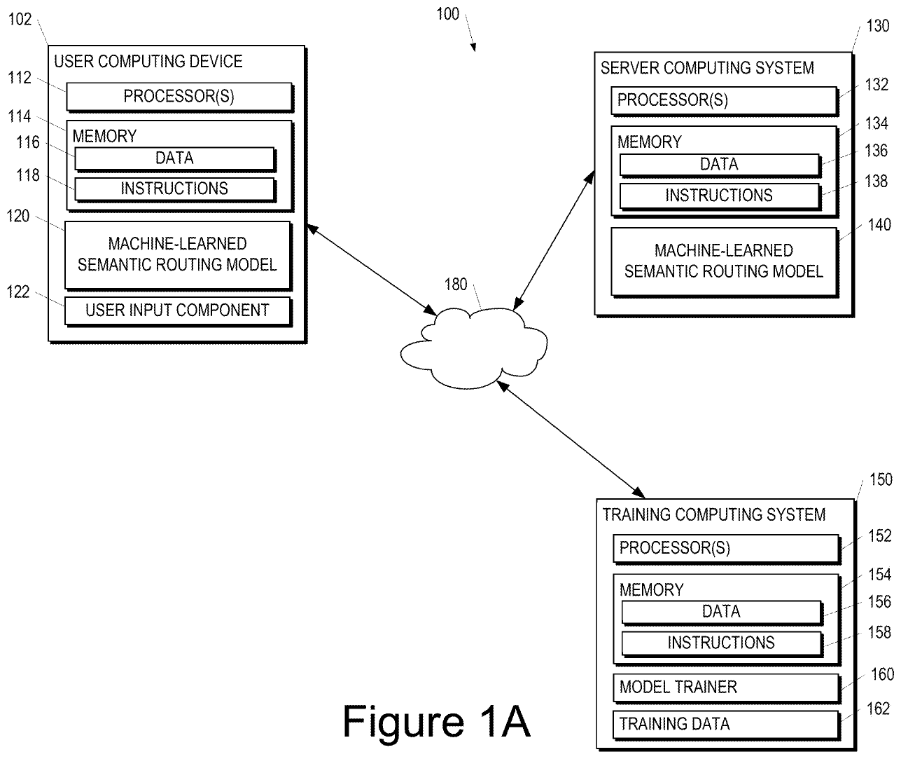

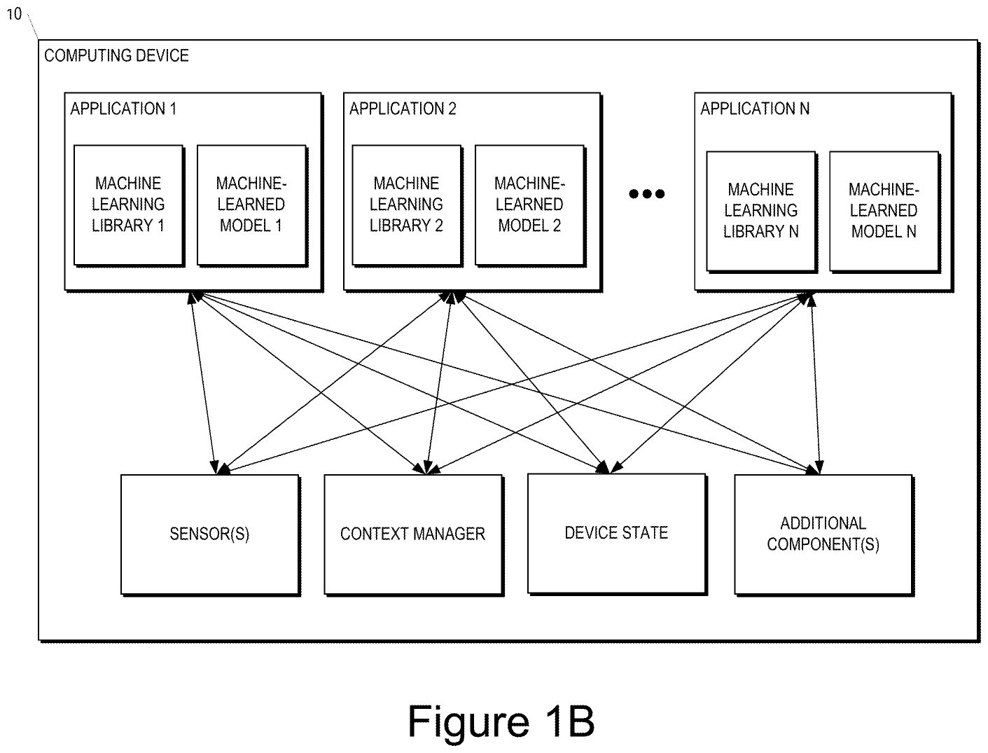

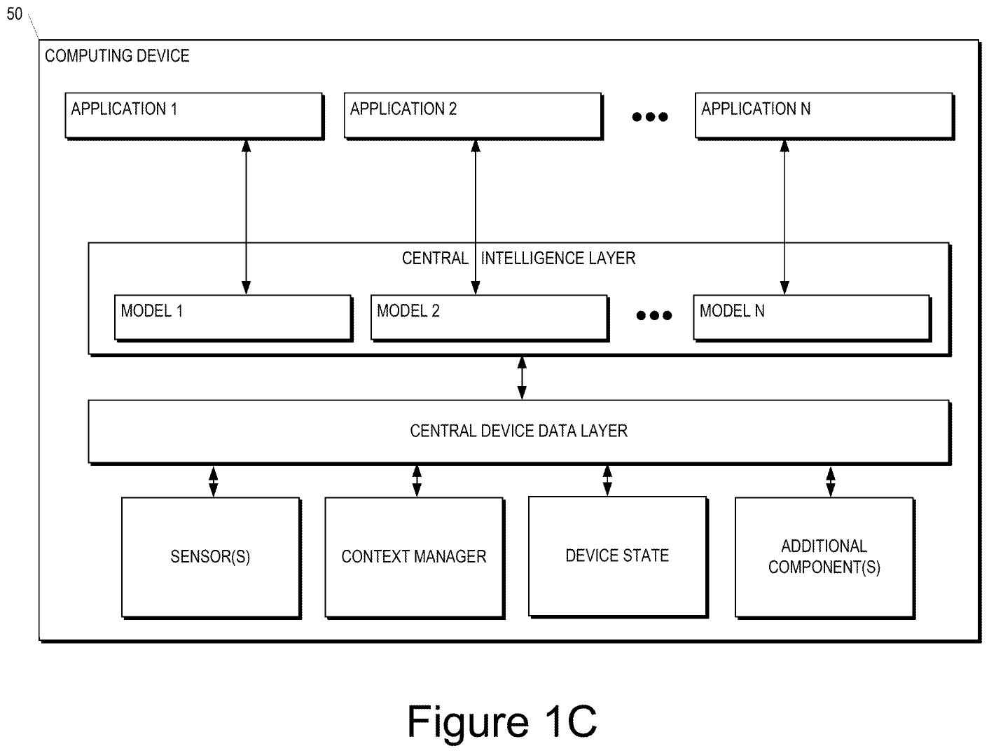

FIG. 1A depicts a block diagram of an example computing system 100 that performs training and utilization of a machine-learned semantic routing model according to some implementations of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned semantic routing model models 120. For example, the machine-learned semantic routing model models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In particular, in some implementations, the machine-learned semantic routing model models 120 can be, or otherwise include, models trained to process textual content or portions of models trained to process textual content. For example, a model such as a LLM is trained to generate textual content based on a textual input. To do so, LLMs generally include a decoder portion (and, in some instances, an and/or decoder portion) that processes a textual input to generate an intermediate representation of the textual input (e.g., a series of tokens, etc.). This intermediate representation is further processed to eventually generate the textual output. However, the decoder portion of the LLM can, in some implementations, be included in the machine-learned semantic routing model models 120 so that textual inputs from users (e.g., “I want a scenic route to the grocery store that avoids highways”) can be processed alongside conventional mapping information.

Similarly, in some implementations, the machine-learned semantic routing model models 120 can include encoder or decoder portions from other foundational models. For example, the machine-learned semantic routing model models 120 can include an encoder and/or decoder portion from a foundational computer vision model trained to generate an intermediate representation of image data (e.g., video, still images, renderings, textures, etc.). For another example, the machine-learned semantic routing model models 120 can include an encoder and/or decoder portion from a foundational audio model trained to generate an intermediate representation of audio data (e.g., recordings, speech, etc.). In such fashion, the machine-learned semantic routing model models 120 can leverage multimodal inputs to more accurately generate routes for users.

It should be noted that certain foundational models, or portions of foundational models (e.g., encoder and/or decoder portions, etc.) are discussed as being included in the machine-learned semantic routing model models 120. However, in some implementations, such foundational models or model portions can be stored and instantiated separately from the machine-learned semantic routing model models 120. More generally, such foundational models or model portions may be utilized in conjunction with the machine-learned semantic routing model models 120 but may also be instantiated, executed, stored, etc. separately from the machine-learned semantic routing model models 120. Specific portions and layers of the machine-learned semantic routing model models 120 will be discussed in greater detail further in the specification.

In some implementations, the one or more machine-learned semantic routing models 120 can be received from the server computing system 130 over network 180, stored in the user computing device memory 114, and then used or otherwise implemented by the one or more processors 112. In some implementations, the user computing device 102 can implement multiple parallel instances of a single machine-learned semantic routing model 120 (e.g., to perform parallel semantic routing across multiple instances of the machine-learned semantic routing model 120).

The machine-learned semantic routing model 120 can perform a wide variety of mapping related tasks. More particularly, the machine-learned semantic routing model 120 can process mapping information, and/or additional, map-related information, to generate a mapping-related model output. In some implementations, the machine-learned semantic routing model 120 can process model inputs to generate predicted route segments. These model inputs can include previous or current route segments, information indicative of a routing request from a user, image data that depicts a location to which a route is requested, information descriptive of multiple possible locations, contextual information (e.g., information indicating available transportation options, user preferences, weather conditions, etc.), itinerary requests, or any other type or manner of input related to mapping.

Additionally, or alternatively, in some implementations, the machine-learned semantic routing model 120 can process model inputs to generate semantic mapping information. Generally, semantic mapping information can refer to information that describes a semantic understanding of a route, geographic location, point of interest, etc. For example, the model input may be a query that requests route segments that are most likely to be traveled by users in search of restaurants. The model output can be semantic mapping information that includes predicted route segments corresponding to the query. For another example, the model input can be a query to identify characteristics of users that navigate a particular route segment. The semantic mapping information can indicate characteristics common to users that navigate the particular route segment (e.g., types of vehicles used, modes of transportation used, consumer preferences, etc.). For another example, the model input can be a request to identify particular characteristics of a route, and the semantic mapping information can describe characteristics of a route or of route segments (e.g., scenic, hazardous in weather conditions, adjacent to certain POI, low traffic, etc.). For yet another example, the model input can be a request to describe a particular route or route segment, and the semantic mapping information can include textual content, image content, and/or audio content descriptive of the route or of route segments.

Additionally or alternatively, one or more machine-learned semantic routing models 140 can be included in or otherwise stored and implemented by the server computing system 130 that communicates with the user computing device 102 according to a client-server relationship. For example, the machine-learned semantic routing models 140 can be implemented by the server computing system 130 as a portion of a web service (e.g., a mapping service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned semantic routing models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

It should be noted that generally, as described herein, “training” the model can also refer to “fine-tuning” or additional training/tuning iterations performed for the model. For example, an initial training session may be performed to train a model, and the parameters of the model may be locked. After utilizing the model at inference stage for a certain period of time, additional tuning iterations can be performed to “fine-tune” the model to perform additional tasks, or to increase model performance at current tasks.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. Alternatively, gradient-free methods may be utilized to update parameters.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned semantic routing models 120 and/or 140 based on a set of training data 162. The training data 162 can include training data for pre-training and for fine-tuning the models 120 and/or 140. For example, the training data can include multiple sets of pre-training data. A pre-training pair can include route segments for a route previously traveled by a user of a mapping service, or a simulated route traveled by a simulated user. The pre-training pair can also include route characteristic information. The route characteristic information can be, or otherwise include, metadata associated with the route traveled by the user. The route characteristic information can indicate method(s) of transportation used, total time, traffic information, entities (e.g., POIs, businesses, landmarks, residences, etc.) located along or close to the route, initial request(s) made by the user, geolocation information (e.g., starting location and destination location coordinates), etc.

In some implementations, pre-training pairs can be created dynamically. In particular, a single route that includes N segments can be utilized to generate N−1 training pairs that can be utilized in various ways. For example, a training task in which K+1, . . . , N (continuations) route segments are to be predicted given given 1, 2, . . . , K. For another example, a training task in which, given 1, 2, . . . , _, K+1, . . . , N predict K (masking segments).

The model trainer 160 can train the machine-learned semantic routing models 120 and/or 140 by masking certain route segments of a pre-training pair and then processing the pre-training pair with the machine-learned semantic routing models 120 and/or 140 to obtain a model output. The model output can include predicted route segments for the masked route segments. The model trainer 160 can then train and evaluate an optimization function that evaluates a difference between the masked route segments and the predicted route segments. Based on the optimization function, the model trainer can adjust values of parameters of the machine-learned semantic routing models 120 and/or 140.

The training data 162 can further include fine-tuning data to fine-tune the machine-learned semantic routing models 120 and/or 140. The type or manner of fine-tuning data included in the training data 162 can vary based on the task(s) for which the machine-learned semantic routing models 120 and/or 140 are being fine-tuned to perform. For example, assume that the machine-learned semantic routing models 120 and/or 140 have been pre-trained and are being fine-tuned to generate a semantic textual description of a route. A set of fine-tuning data can include routing information that indicates a scenic route along the coastline, and a ground-truth textual description of the route. The model trainer 160 can process the routing information with the machine-learned semantic routing models 120 and/or 140 to generate a model output that includes a predicted textual description of the route. The model trainer 160 can train the machine-learned semantic routing models 120 and/or 140 based on an optimization function that evaluates a difference between the ground-truth textual description and the predicted textual description.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.) that can be further utilized to generate routing information, map-related information, etc. As another example, the machine-learned model(s) can process the image data to generate a prediction output that can be further utilized to generate routing information, map-related information, etc.

In some implementations, the input to the machine-learned model(s) of the present disclosure can be text or natural language data. The machine-learned model(s) can process the text or natural language data to generate an output. As an example, the machine-learned model(s) can process the text or natural language data to generate a latent text embedding output that can be further utilized to generate routing information, map-related information, etc. As another example, the machine-learned model(s) can process the text or natural language data to generate a translation output that can be further utilized to generate routing information, map-related information, etc. As another example, the machine-learned model(s) can process the text or natural language data to generate a semantic intent output that can be further utilized to generate routing information, map-related information, etc.

In some implementations, the input to the machine-learned model(s) of the present disclosure can be speech data. The machine-learned model(s) can process the speech data to generate an output. As an example, the machine-learned model(s) can process the speech data to generate a speech recognition output that can be further utilized to generate routing information, map-related information, etc. As another example, the machine-learned model(s) can process the speech data to generate a speech translation output that can be further utilized to generate routing information, map-related information, etc. As another example, the machine-learned model(s) can process the speech data to generate a latent embedding output. As another example, the machine-learned model(s) can process the speech data to generate a textual representation output (e.g., a textual representation of the input speech data, etc.) that can be further utilized to generate routing information, map-related information, etc.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output that can be further utilized to generate routing information, map-related information, etc. As another example, the machine-learned model(s) can process the latent encoding data to generate a prediction output that can be further utilized to generate routing information, map-related information, etc.

In some implementations, the input to the machine-learned model(s) of the present disclosure can be sensor data. The machine-learned model(s) can process the sensor data to generate an output. As an example, the machine-learned model(s) can process the sensor data to generate a recognition output that can be further utilized to generate routing information, map-related information, etc. As another example, the machine-learned model(s) can process the sensor data to generate a visualization output that can be further utilized to generate routing information, map-related information, etc.

In some cases, the input includes visual data and the task is a computer vision task that can be further utilized to generate routing information, map-related information, etc. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task that can be further utilized to generate routing information, map-related information, etc. The output may comprise a text output which is mapped to the spoken utterance. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs training and/or pre-training of a machine-learned semantic routing model according to some implementations of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that generates mapping information or mapping-related information with a machine-learned semantic routing model according to some implementations of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

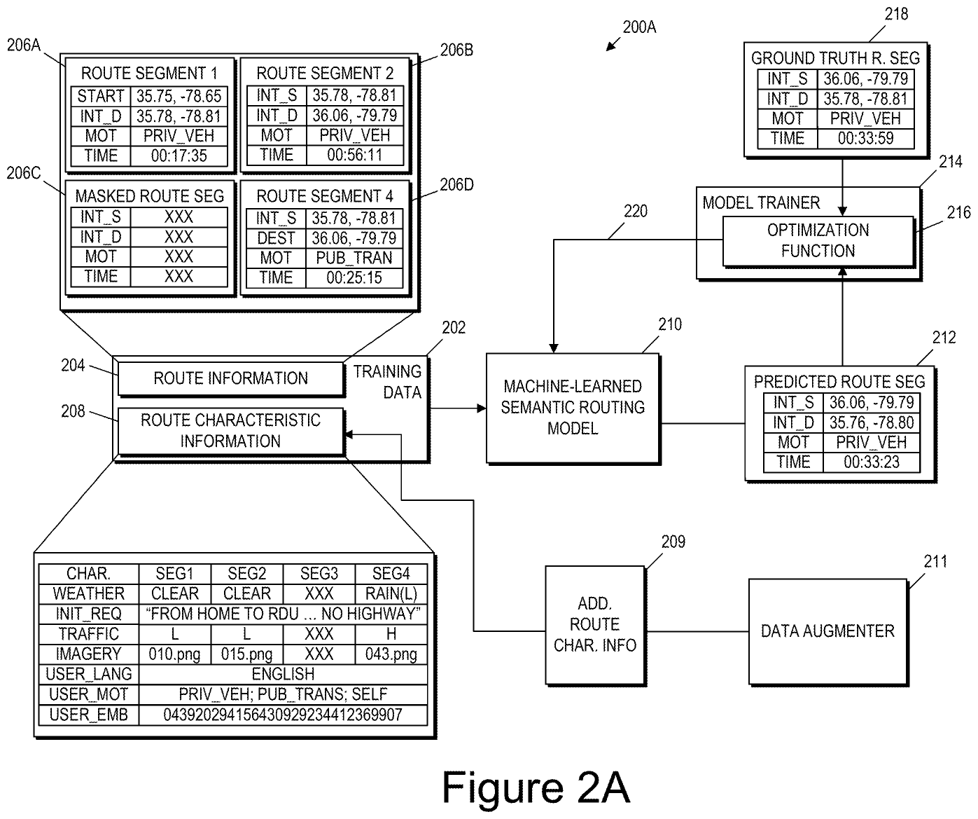

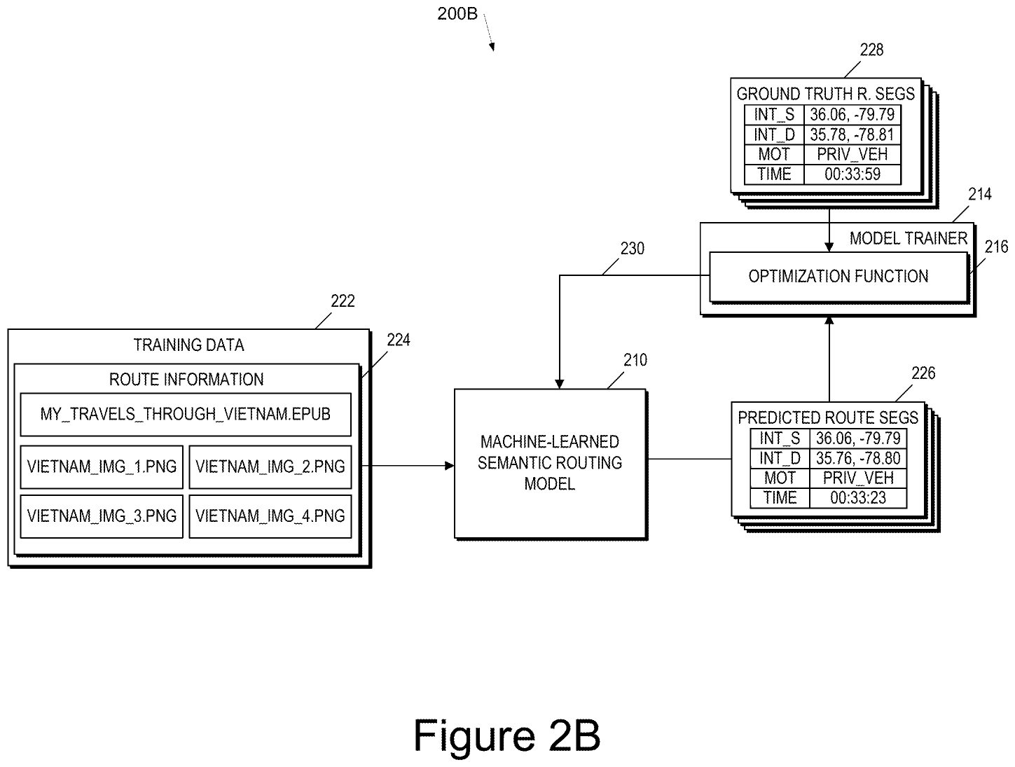

FIG. 2A is a data flow diagram 200A for performing pre-training for a machine-learned semantic routing model according to some implementations of the present disclosure. In particular, the data flow diagram 200 includes training data 202. The training data 202 can be, or otherwise include, data used to perform pre-training of the machine-learned semantic routing model. The training data 202 can include route information 204. The route information 204 can indicate a route from a starting location to a destination location. In some implementations, the route information 204 can indicate a route previously traveled by a user, such as a user of a mapping application. In this instance, the route information 204 is stringently processed to remove any identifying information as to preserve user privacy. Alternatively, in some implementations, the route information 204 can indicate a simulated route, or can include media and/or multimedia that is generally descriptive of a route. Alternate sources and/or types of route information 204 will be discussed in greater detail with regards to FIG. 2B.

In particular, the route information 204 can indicate a route that includes multiple route segments 206A, 206B, 206C, and 206D (generally, route segments 206). Each of the route segments 206 can include, or otherwise indicate, a starting location, a destination location, a method of transportation, a quantity of time spent navigating the route segment, and any other type or manner of information that is relevant to a particular route segment 206 of the route indicated by the route information 204. To follow the depicted example, the route segment 206A can be a first route segment in the route, and as such, the start location of the route segment 206A can be the same start location as the route indicated by the route information 204. The route segment 206A can have an intermediate destination different than the final destination of the route indicated by the route information 204. In some implementations, the intermediate destination of a route segment can be the intermediate starting location of the next route segment immediately following the current route segment. To follow the depicted example, the intermediate destination location of route segment 206A (e.g., 35.78,-78.81) can be the same as the starting intermediate starting location of the route segment 206B that immediately follows route segment 206A (e.g., 35.78,-78.81).

As depicted, in some implementations, the route segments 206 can each indicate locations (e.g., starting locations, destination locations, etc.) using latitude/longitude coordinates. Additionally, or alternatively, in some implementations, the route segments 206 can indicate locations in an alternate manner. For example, the route segments 206 can indicate a location based on the name of an entity associated with the location (e.g., a particular landmark, POI, business, residence, etc.). For another example, the route segments 206 can encode a location as an address.

Additionally or alternatively, as depicted, in some implementations the route segments 206 can indicate a method of transportation utilized to traverse a particular route segment. For example, the route segment 206A indicates that a private vehicle (e.g., PRIV_VEH) is used to traverse the route segment, while route segment 206D indicates that public transportation (e.g., PUB_TRANS) was used to traverse the route segment.

Additionally or alternatively, as depicted, in some implementations the route segments 206 can indicate a time spent traversing the route segments. For example, the route segment 206A indicates that traversal of the route segment took 17 minutes and 35 seconds. It should be noted that the time taken to traverse a route segment can be calculated such that only time spent directly traversing the segment is evaluated. In other words, the time spent traversing a route segment can exclude time spent by a user doing something other than traversing the route segment (e.g., stopping for food or gas, shopping, taking a detour, etc.).

The route indicated by route information 204, and the route segments 206, can utilize any type or manner of transportation infrastructure, recreational resources or infrastructure, etc. In some implementations, the route indicated by route information 204 can be a route that traverses roads (e.g., streets, highways, bridges, etc.). Additionally, or alternatively, in some implementations, the route indicated by route information 204 can traverse additional transportation infrastructure that is not accessible to conventional ground-based public or private transportation vehicles such as cars, trucks, buses, etc. For example, a route, or segment(s) of a route, can traverse sidewalks, bike lanes, hiking trails, alleyways, buildings (e.g., entering a building with a connector such as a skybridge or subway and taking the connector to another building, etc.), tunnels, bodies of water, airspace, etc. Additionally, or alternatively, in some implementations, the route, or segment(s) of the route, can be traversed via transportation vehicles other than conventional ground-based transportation vehicles. For example, a route, or segment(s) of a route, can be traversed via trains, subways, trolley cars, personal transportation devices (e.g., bicycles, scooters, single-wheel devices, electronic devices, etc.), boats, ferries, airplanes, helicopters, Vertical Take-off and Landing (VTOL) vehicles, etc.

Additionally, or alternatively, in some implementations, the route, or segment(s) of the route, can traverse recreational resources or infrastructure. For example, the route, or segment(s) of the route, can include ski trails, hiking trails, biking trails, campgrounds, etc. Additionally, or alternatively, in some implementations, the route, or segment(s) of the route, can traverse virtual resources or infrastructure. For example, the route, or segment(s) of the route, can traverse across virtual spaces of video games, simulations, etc. In particular, the route, or segment(s) of the route, can traverse such spaces in the same manner as corresponding non-virtual transportation resources. For example, assume that a virtualized fictional city in a video game includes transportation infrastructure analogous to that of modern-day cities (e.g., roads, public transportation, bike lanes, etc.). The route, or segment(s) of the route, can traverse the transportation infrastructure of the virtualized fictional city in the same manner as a modern-day city is traversed.

Additionally, or alternatively, in some implementations, the route, or segment(s) of the route, can leverage, incorporate, or otherwise interface with providers of transportation services. For example, segment(s) of a route across city roads may be traversed using rideshare services, taxis, etc. For another example, segment(s) of a route from one city to another city may be traversed using commercial flight services. For yet another example, segment(s) of a route from one city to another city may be traversed using public transportation (e.g., buses, trains, etc.).

Additionally, or alternatively, in some implementations, the route can be a multimodal route in which different segments of the route traverse different types of transportation infrastructure, and/or utilize different methods of transportation. For example, a first segment of the route can traverse a road to arrive at a train station, and then the second segment of the route may traverse the railway using the train. For another example, a first segment of a route can utilize a bicycle to traverse a recreational mountain biking trail to a parking lot at which a user's personal vehicle is kept, and then a second segment of the route can utilize the personal vehicle to return to the user's home.

The training data 202 can include route characteristic information 208. The route characteristic information 208 can be, or otherwise include, metadata or meta-information that indicates various segment-level and/or route-level characteristics of the route indicated by the route information 204. To follow the depicted example, the route characteristic information 208 can include a weather characteristic that indicates weather conditions at the time each of the route segments 206 was traversed. For another example, the route characteristic information 208 can include the initial request made by the user that caused generation of the route indicated by the route information 204 (e.g., “From home to RDU . . . no highway.” For another example, the route characteristic information 208 can include a traffic characteristic that indicates traffic conditions at the time each of the route segments 206 was traversed. As such, it should be broadly understood that the route characteristic information 208 can, on a per-segment or per-route basis, include any type or manner of information associated with the route or traversal of the route indicated by the route information 204.

In some implementations, the route characteristic information 208 can include images associated with route segments 206. For example, a vehicle used to traverse route segments 206A and 206B can include camera sensors (e.g., to facilitate autonomous vehicle operations, etc.). The route characteristic information 208 can include images captured at the starting location and/or destination location of the route segments 206A and 206B with the camera sensors of the vehicle. For another example, the route characteristic information 208 can include publicly available street-view imagery, traffic sensor imagery, satellite imagery, etc. of the starting and/or destination locations of the route segments 206.

In some implementations, the route characteristic information 208 can include historical user information specific to the user that traversed the route indicated by the route information 204. The historical user information, after being processed to remove any identifying information to preserve user privacy, can indicate various characteristics of the user that may be related to traversal of the route segments 206. For example, the historical user information can indicate language(s) spoken by the user. For another example, the historical user information can indicate method(s) of transportation available to the user (e.g., PRIV_VEH, PUB_TRANS, SELF, etc.), and/or whether the user is capable of on-foot or assisted on-foot transportation (e.g., bicycles, electric devices, mobility devices, etc.). For yet another example, the historical user information can include a user information embedding that serves as a latent representation of user information relevant to mapping and/or route traversal. In this manner, the historical user information can capture details that may or may not be relevant in a privacy-preserving manner.

In some implementations, the route characteristic information 208 can be augmented with additional route characteristic information 209. In particular, data augmenter 211 can obtain additional route characteristic information 209, and can augment the route characteristic information 208 with the additional route characteristic information 209. The additional route characteristic information 209 can include information related to route segments 206, entities located along route segments 206 (e.g., businesses, POIs, landmarks, etc.), user-generated content associated with route segments 206, etc. For example, the additional route characteristic information 209 can include user-submitted reviews of businesses along particular route segments 206. In some implementations, the additional route characteristic information 209 may include user reviews specifically for the route segments 206. For example, if the route segments 206 are recreational (e.g., hiking trail segments, ski trail segments, scenic road segments, etc.), the additional route characteristic information 209 can include reviews for the route segments 206 from user review web sources. In some implementations, the additional route characteristic information 209 can include information from mapping services, applications, sources, etc. different than mapping service(s) associated with route information 204. For example, the additional route characteristic information 209 can include route metadata from another mapping application or service, different Geographic Information Systems (GIS), review platforms, etc.

It should be noted that the route characteristic information 208 is only illustrated as being distinct from the route information 204 to more clearly illustrate various implementations of the present disclosure. Rather, in some implementations, the route information 204 can include certain characteristics that are illustrated as being included in the route characteristic information 208 (e.g., per-segment weather characteristics, per-segment traffic characteristics, etc.), or may entirely incorporate the route characteristic information 208. Additionally, or alternatively, in some implementations, the route characteristic information 208 can include characteristics or information that are illustrated as being included in the route segments 206 (e.g., method of transportation, time to traverse the segment, starting/destination locations, etc.).

The training data 202 can be utilized to train, and/or fine-tune, a machine-learned semantic routing model 210. The machine-learned semantic routing model 210 can be any type or manner of model trained at least in part to process the route information 204 and the route characteristic information 208, along with any type or manner of data included in the route information 204 and the route characteristic information 208. To train, and/or fine-tune, the machine-learned semantic routing model 210, one or more route segments 206 can be masked prior to processing with the machine-learned semantic routing model 210. In some implementations, the training data 202 can be obtained after masking has been applied to the training data 202. Alternatively, in some implementations, masking can be applied to the training data 202 after the training data 202 has been obtained.

To follow the depicted example, the route segment 206C can be masked by obscuring or otherwise removing the information associated with the route segment 206C. In some implementations, the route characteristic information 208 associated with the masked route segment 206C can also be masked. For example, the per-segment traffic characteristic for the route segment 206C can be masked. Alternatively, in some implementations, the route characteristic information 208 associated with the masked route segment 206C can remain unmasked or can be partially masked. In some implementations, a single route segment 206 can be masked. Alternatively, in some implementations, multiple route segments 206 can be masked (e.g., sequential route segments, non-sequential route segments, etc.).

The training data 202 can be processed with the machine-learned semantic routing model 210 to obtain a predicted route segment 212. The predicted route segment 212 can be a prediction for the masked route segment 206C. A model trainer 214 can evaluate the predicted route segment 212 with an optimization function 216. In particular, the optimization function 216 can evaluate difference(s) between the predicted route segment 212 and a ground truth route segment 218. The ground truth route segment 218 can be the route segment 206C prior to application of masking (i.e., the “original” route segment 206C). Based on the optimization function 216, the model trainer 214 can apply adjustments 220 to parameter(s) (or value(s) of parameter(s)) of the machine-learned semantic routing model 210. In such fashion, the machine-learned semantic routing model 210 can be trained, or pre-trained, to efficiently and accurately predict route segments given a route and information associated with the route.

FIG. 2B is a data flow diagram 200B for performing a subsequent pre-training iteration for the machine-learned semantic routing model using route information different than the route information of FIG. 2A according to some implementations of the present disclosure. In particular, a second set of training data 222 can be obtained to perform another iteration of fine-tuning, training, or pre-training, for the machine-learned semantic routing model 210.

The training data 222 can include route information 224. Unlike the route information 204 of the training data 202, the route information 224 of the training data 222 can be, or otherwise include, content that is semantically indicative of a route. To follow the depicted example, the route information 224 can include a file for a book titled “My Travels Through Vietnam” (e.g., MY_TRAVELS_THROUGH_VIETNAM.epub) along with corresponding images extracted from the book (e.g., VIETNAM_IMG_1.png. VIETNAM_IMG_2.png, etc.). It should be noted that although the route information 224 does not explicitly demarcate particular route segments, such as the route segments 206 of the route information 204 of FIG. 2A, the machine-learned semantic routing model 210 can be trained, and/or fine-tuned, to identify and partition the route semantically indicated by the route information 224.

To follow the depicted example, assume that the content of the book included in the route information 224 describes a vacation during which the author visits four major cities in Vietnam. The four images included in the route information 224 can respectively correspond to the four major cities. The machine-learned semantic routing model 210 can process the training data 222 to generate four predicted route segments 226. The predicted route segments 226 can correspond to routes between the four major cities visited by the author. In this manner, the machine-learned semantic routing model 210 can be trained to identify the characteristics of a route semantically described in media or multimedia. The machine-learned semantic routing model 210 can also be trained to partition the identified route into specific segments.

The model trainer 214 can evaluate the predicted route segments 226 with the optimization function 216. The optimization function 216 can evaluate difference(s) between the predicted route segments 226 and ground truth route segment 228. The ground truth route segments 228 can be route segments that accurately correspond to the route described by the author in the route information 224. For example, the ground truth route segments 228 may be created by a user that has read the book included in the route information 224. For another example, the ground truth route segments 228 may be generated as an output, or based on an output, of an LLM that processes at least some of the book included in the route information 224. Based on the optimization function 216, the model trainer 214 can apply adjustments 230 to value(s) of parameter(s) of the machine-learned semantic routing model 210.

Although FIG. 2B illustrates a book and corresponding images as route information 224, any type or manner of media or multimedia can be utilized as route information 224 to train, and/or fine-tune, the machine-learned semantic routing model 210. For example, any type or manner of written material can be utilized as route information 224, such as books, articles, blog posts, social media posts, scraped or aggregated textual content, textual content generated by a machine-learned model, etc. For another example, any type or manner of image or video data can be utilized as route information 224, such as images, movies, television shows, etc. For yet another example, any type or manner of three-dimensional representation, simulated information, etc. can be utilized to train the machine-learned semantic routing model 210, such as simulated maps or spaces, etc.

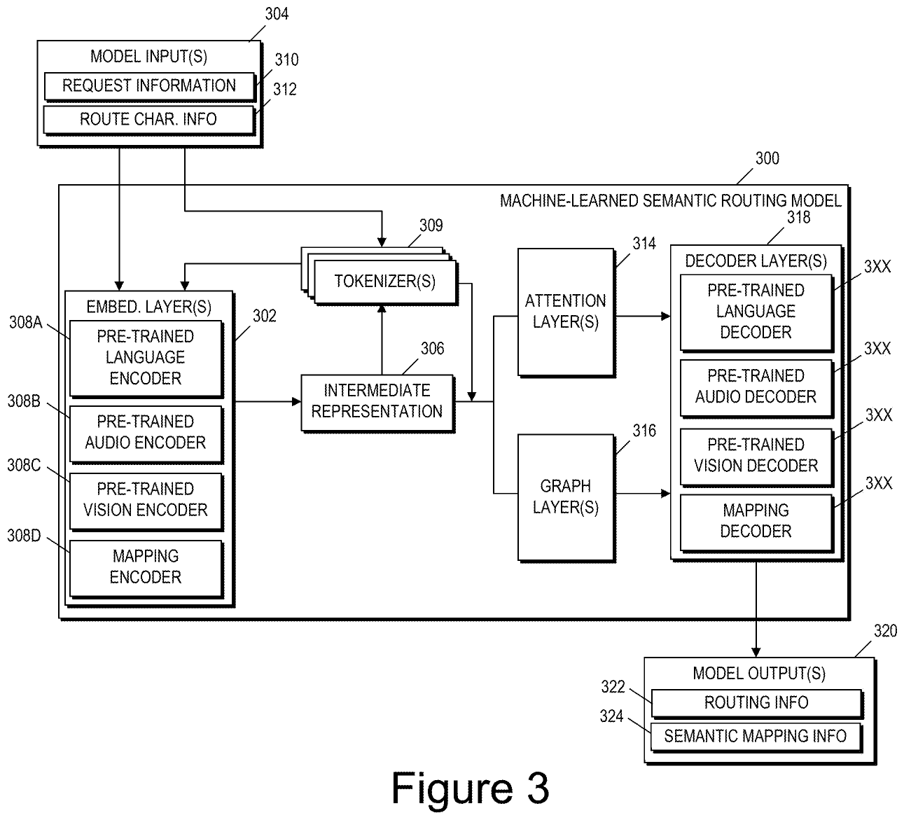

FIG. 3 is a block diagram for an example machine-learned semantic routing model 300 according to some implementations of the present disclosure. It should be noted that any portion(s) of the machine-learned semantic routing model 300 described herein with regards to FIG. 3 may, or may not, be “components” or otherwise integrated with the machine-learned semantic routing model 300. In some implementations, the machine-learned semantic routing model 300 may generally refer to a singular model that includes multiple model portions (e.g., encoders, decoders, tokenizers, etc.). Alternatively, in some implementations, the machine-learned semantic routing model 300 may refer to only some of the model portions described herein. For example, a computing system may instantiate embedding layers 302 to generate an intermediate representation 306, and then instantiate decoder layers 318 to process the intermediate representation 306. For another example, a computing system may provide model inputs 304 to another computing system that has instantiated embedding layers 302 for processing, and in response, can receive the intermediate representation 306 from the other computing system.

The machine-learned semantic routing model 300 can include one or more embedding layers 302. The embedding layer(s) 302 can process model inputs 304 to generate an intermediate representation 306 of the model inputs 304. In some implementations, the embedding layer(s) 302 can include a pre-trained language encoder 308A (e.g., a decoder portion of an LLM, etc.). The pre-trained language encoder 308A can be trained to generate an intermediate representation of textual content. For example, the model inputs 304 can include request information 310 and route characteristic information 312. The request information 310 can include textual content descriptive of a user request for a certain route, certain route characteristics, certain mapping-related information etc. The pre-trained language encoder 308A can process the textual content to obtain an intermediate representation of the textual content. The intermediate representation 306 can include, or can be based on, the intermediate representation of the textual content.

In some implementations, the model inputs 304 can include route(s), or route segment(s), that were previously generated for a user. For example, assume that a user has provided feedback information rating two routes particularly highly. Route information indicative of the previous routes can be included in the model inputs to provide “few-shot” prompting to the machine-learned semantic routing model 300. In other words, previous routes that a user has rated highly can serve as context for a routing request, and can encourage the machine-learned semantic routing model 300 to generate routes similar to those indicated by the model inputs 304.

Additionally, or alternatively, in some implementations, the embedding layer(s) 302 can include a pre-trained audio encoder 308B (e.g., the encoder portion of a foundational audio model, etc.). The pre-trained audio encoder 308B can be trained to generate an intermediate representation of audio data. For example, the request information 310 can include audio data that includes a recording of a spoken utterance from a user that describes a user request for a certain route, certain route characteristics, etc. The pre-trained audio encoder 308B can process the audio data to obtain an intermediate representation of the audio data. The intermediate representation 306 can include, or can be based on, the intermediate representation of the audio data.

Additionally, or alternatively, in some implementations, the embedding layer(s) 302 can include a pre-trained vision encoder 308C (e.g., the encoder portion of a foundational vision model, etc.). The pre-trained audio encoder 308C can be trained to generate an intermediate representation of image data (e.g., images, video data, etc.). For example, the request information 310 can include image data provided by a user that depicts a certain destination location. The pre-trained vision encoder 308C can process the image data to obtain an intermediate representation of the image data. The intermediate representation 306 can include, or can be based on, the intermediate representation of the image data.

Additionally, or alternatively, in some implementations, the embedding layer(s) 302 can include a mapping encoder 308D. The mapping encoder 308D can at least partially be trained with pre-training data as described with regards to training data 202 of FIG. 2A and training data 222 of FIG. 2B. In particular, the mapping encoder 308D can be trained to generate an intermediate representation of map information and/or route information. For example, the request information 310 and/or the route characteristic information 312 can include map information and/or route information. The mapping encoder 308D can process the map information and/or route information to obtain an intermediate representation of the map information and/or route information. The intermediate representation 306 can include, or can be based on, the intermediate representation of the map information and/or route information.

It should be noted that, in some implementations, the encoders 308A-308D can be encoder/decoder architectures, decoders, etc. More particularly, the encoder(s) 308A-308D can refer to some type of machine-learned model or layer(s) of a machine-learned model that can process model inputs to generate the intermediate representation 306.

In some implementations, the machine-learned semantic routing model 300 can include, or can otherwise access, tokenizers 309. The tokenizers 309 can be machine-learned models, or portions of models, that can generate a stream of tokens based on an input. In some implementations, the tokenizers 309 can process model input(s) 304 to obtain the intermediate representation 306, which can be, or otherwise include, tokens generated by the tokenizer(s) 309. Alternatively, in some implementations, the tokenizers 309 can process the model input(s) 304 to generate token streams that can be processed by the embedding layer(s) 302 to obtain the intermediate representation 306. Alternatively, in some implementations, the tokenizers 309 can process the intermediate representation 306 to generate token streams that can be processed by the attention layer(s) 314 and/or the graph layer(s) 316.

In some implementations, the tokenizer 309 can generate multiple token streams each specific to a particular type of information. For example, the tokenizers 309 can include an audio tokenizer that processes the model inputs 304 to generate a stream of audio tokens (e.g., discretizing raw audio into a series of tokens at a certain rate). For another example, the tokenizers 309 can include a vision tokenizer that processes the model inputs 304 to generate a stream of image tokens (e.g., by chunking an image using 16×16 chunking slices, etc.).

In some implementations, the embedding layer(s) 302 can include a single encoder that can process stacked tokens from multiple modalities. For example, assume that the model input(s) 304 includes image data and audio data. The tokenizers 309 can process the model input(s) 304 to obtain an audio token stream and an image token stream. The audio token stream and the image token stream can be stacked and processed by the single encoder to generate the intermediate representation 306.

In some implementations, the machine-learned semantic routing model 300 can include attention layer(s) 314. The attention layer(s) 314 can apply weights to certain portions of an input that indicate a relative importance of the portions of the input. For example, the attention layer(s) 314 may be, or otherwise include, a transformer-based self-attention mechanism. Additionally, or alternatively, in some implementations, the machine-learned semantic routing model 300 can include graph layer(s) 316. The graph layer(s) 316 can be layer(s) of a graph neural network model. The graph layer(s) 316 can represent a route, and the segments of the route, as a graph of nodes and edges, where nodes represent starting locations and destination locations, and edges represent route segments that navigate between the starting locations and destination locations. Additionally, in some implementations, the graph layer(s) 316 can include additional relationships between nodes in a trip that includes multiple routes (e.g., a route from home to the airport, from the airport to a second airport, from the second airport to a hotel, etc.).

The machine-learned semantic routing model 300 can include decoder layer(s) 318. The decoder layer(s) 318 can process some intermediate output (e.g., intermediate representation 306, an output from attention layer(s) 314 or graph layer(s) 316, etc.) to obtain model outputs 320. The model outputs 320 can include routing information 322 and/or semantic mapping information 324. The routing information 322 can indicate a route and/or a route segment. For example, the model input(s) 304 may indicate a request for an alternate route segment for a route segment of a planned route. The routing information 322 can include information indicative of a suggested route segment responsive to the request.

The semantic mapping information 324 can include information descriptive of a route, a route segment, or certain route characteristics. For example, the model input(s) 304 may indicate a request to describe a particular route. The semantic mapping information 324 can include textual content descriptive of the particular route in response to the request. For another example, the model input(s) 304 may indicate a request to identify the most popular businesses located along a route. The semantic mapping information 324 can include content indicative of the most popular businesses along the particular route in response to the request (e.g., images of the business, textual content descriptive of the businesses, mapping and/or routing information associated with the businesses, user reviews corresponding to the businesses, etc.).

In some implementations, the decoder layer(s) 318 can include a pre-trained language decoder 326A. For example, the pre-trained language decoder 326A can be a decoder for an LLM model that includes the pre-trained language encoder 308A. The pre-trained language decoder 326A can be trained to generate a language output based on some intermediate output (e.g., the intermediate representation 306, etc.). For example, assume that the request information 310 includes a request to describe a particular route. The pre-trained language decoder 326A can process some intermediate output to generate textual content that describes the particular route indicated by the model input(s) 304. The textual content can be included in the semantic mapping information 324.

In some implementations, the decoder layer(s) 318 can include a pre-trained audio decoder 326B. For example, the pre-trained audio decoder 326B can be a decoder for a foundational audio model that includes the pre-trained audio encoder 308B. The pre-trained audio decoder 326B can be trained to generate an audio output based on some intermediate output (e.g., the intermediate representation 306, etc.). For example, assume that the request information 310 includes a request to generate audio that describes a particular route. The pre-trained audio decoder 326B can process some intermediate output to generate audio that describes the particular route indicated by the model input(s) 304. The audio can be included in the semantic mapping information 324.

In some implementations, the decoder layer(s) 318 can include a pre-trained vision decoder 326C. For example, the pre-trained vision decoder 326C can be a decoder for a foundational vision model that includes the pre-trained vision encoder 308C. The pre-trained vision decoder 326C can be trained to generate an image output based on some intermediate output (e.g., the intermediate representation 306, etc.). For example, assume that the request information 310 includes a request to depict a particular route in a stylized manner (e.g., “draw this route in the same style as a ski map”). The pre-trained vision decoder 326C can process some intermediate output to generate image data that depicts the particular route in the stylized manner indicated by the model input(s) 304. The image data can be included in the semantic mapping information 324.

In some implementations, the decoder layer(s) 318 can include a mapping decoder 326D. For example, the mapping decoder 326D can be a decoder trained in conjunction with the mapping encoder 308D. The mapping decoder 326D can be trained to generate mapping information and/or routing information based on some intermediate output (e.g., the intermediate representation 306, etc.). For example, assume that the request information 310 includes a request to depict a generate an alternate route segment for a particular route segment of a route. The mapping decoder 326D can process some intermediate output to generate mapping information and/or routing information that indicates a suggested route segment as an alternative for the route segment. The mapping information and/or routing information can be included in the routing information 322.

Additionally, or alternatively, in some implementations, the decoder layer(s) 318 can generate a multimodal model output 320. For example, assume that the request information 310 includes: (a) textual content descriptive of a request to generate an alternate route segment for a particular route segment in a route, and (b) a request to describe the alternate route segment and the differences between the alternate route segment and the particular route segment. The mapping decoder 326D can process some intermediate output to generate a suggested route segment as an alternative for the particular route segment. The pre-trained language decoder 326A can process some intermediate output to generate a textual description of the suggested route segment. The suggested route segment can be included in the route information 322, and the textual description can be included in the semantic mapping information 324. In such fashion, the decoder layer(s) can generate multimodal outputs that include multiple types of data.

### Example Methods

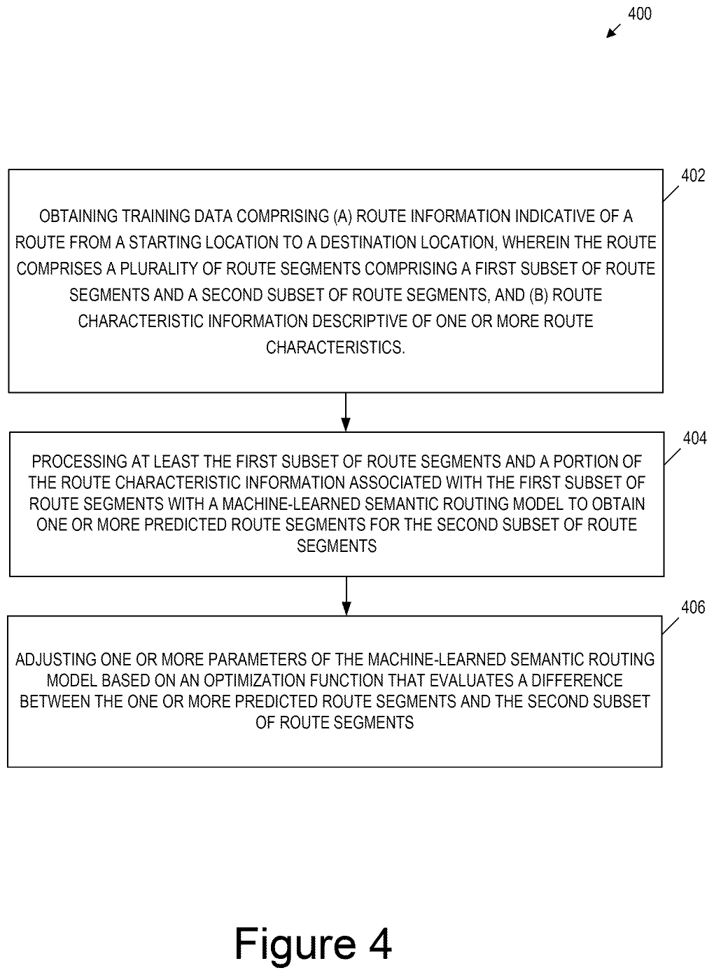

FIG. 4 depicts a flow chart diagram 400 of an example method to perform training, and/or fine-tuning, of a machine-learned semantic routing model according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain training data for training (or “pre-training”) of a machine-learned semantic routing model. The training data can include route information. The route information can indicate a route from a starting location to a destination location. The route can include a plurality of route segments that include a first subset of route segments (e.g., a set of “unmasked” segments) and a second subset of route segments (a set of “masked” route segment(s)). The route information can also include route characteristic information. The route characteristic information can describe one or more route characteristics. Route characteristics can include a type of route (e.g., scenic, efficient, fast, safe, etc.), entities located along the route (e.g., businesses, residences, landmarks, POIs, etc.), average traffic conditions for the route or for segment of the route, average weather conditions for the route or for segment of the route, information associated with a user that traversed the route, etc.

At 404, the computing system can process at least the first subset of route segments and a portion of the route characteristic information associated with the first subset of route segments with a machine-learned semantic routing model to obtain one or more predicted route segments for the second subset of route segments. More specifically, the first subset of route segments can be route segments that are unmasked. The second subset of route segments can be route segment(s) that are masked, or are otherwise not processed with the machine-learned semantic routing model so that the model can predict the segments.

In some implementations, to process the first subset of route segments, the computing system can process the first subset of route segments and the portion of the route characteristic information associated with the first subset of route segments with a first portion of the machine-learned semantic routing model to obtain a latent representation of the first subset of route segments. In some implementations, the first portion of the machine-learned semantic routing model can be, or otherwise include, an encoder portion of a pre-trained LLM. For example, the route information can indicate a second route from a second starting location to a second destination location and a prompt indicative of a request to describe the second route. The model output can include textual content descriptive of the second route.

At 406, the computing system can train, and/or fine-tune, the machine-learned semantic routing model based on an optimization function that evaluates a difference between the one or more predicted route segments and the second subset of route segments.

In some implementations, the computing system can process input data with the machine-learned semantic routing model to obtain a model output. The input data can include route information indicative of one or more first route segments of an incomplete route, and a prompt indicative of a request to generate one or more second route segments with requested route characteristics for the incomplete route. The model output can include the one or more second route segments with the requested route characteristics.

In some implementations, the route information can indicate one or more example routes, a second route including a plurality of second route segments, and a prompt indicative of a request to generate one or more alternate route segments for one or more respective second route segments of the second route based on the one or more example routes. The model output can include the one or more alternate route segments of the second route.

In some implementations, the computing system can process input data with the machine-learned semantic routing model to obtain a model output. The input data can include route information descriptive of a second route including a plurality of second route segments. The model output can include classification information that classifies the route as a first route type of a plurality of route types (e.g., a scenic route type, an efficient route type, a non-highway route type, a tolled route type, a low-traffic route type, etc.). In some implementations, the classification information further classifies a second route segment of the plurality of second route segments as a first route segment type of a plurality of route segment types.

In some implementations, the computing system can process input data with the machine-learned semantic routing model to obtain a model output. The input data can include a current route segment including an intermediate destination location for an existing route. The output data can include one or more candidate route segments. A starting location of each of the one or more candidate route segments can correspond to the intermediate destination location of the current route segment.

In some implementations, the computing system can process input data with the machine-learned semantic routing model to obtain a model output. The input data can include route request information descriptive of a route from a requested starting location to a requested destination location, and preferred route characteristic information descriptive of a preferred route characteristic for the route. The model output can include route information indicative of a route from the requested starting location to the requested destination location that includes the preferred route characteristic.

In some implementations, the computing system can process input data with the machine-learned semantic routing model to obtain a model output. The input data can include one or more images of one or more locations. The output data can include itinerary information indicative of a proposed route that includes at least one of the one or more locations.

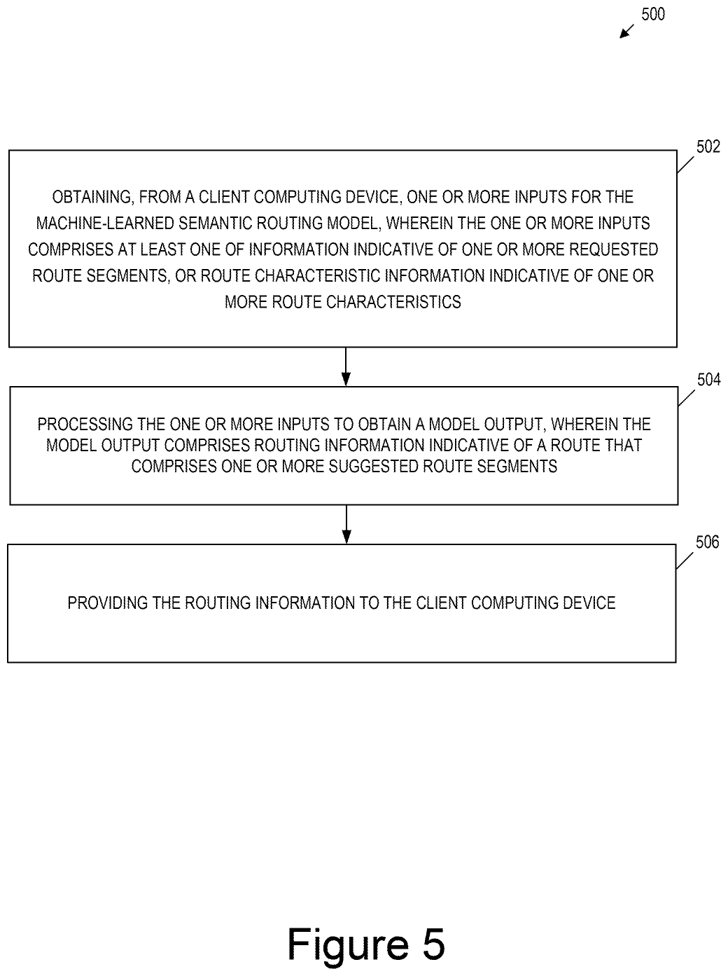

FIG. 5 depicts a flow chart diagram 500 of an example method to perform map-related tasks using a machine-learned semantic routing model according to some implementations of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can obtain, from a client computing device, one or more inputs for a machine-learned semantic routing model. The machine-learned semantic routing model can be a model that is trained to process mapping information to generate a model output that includes suggested route segments and/or information associated with route segments. The one or more inputs can include at least one of request information indicative of a requested route segment and/or a request for mapping-related information, or route characteristic information indicative of one or more route characteristics.

At 504, the computing system can process the one or more inputs to obtain a model output. The model output can include at least one of (a) routing information indicative of a route that comprises one or more suggested route segments, or (b) semantic mapping information associated with the route. In particular, routing information can be, or otherwise include, data for mapping applications or information descriptive of particular route(s) or route segment(s). For example, the routing information can be data that, when provided to an Application Programming Interface (API) for a mapping application, causes the application to generate a route or modify an existing route based on the model output. For another example, the routing information can be textual content descriptive of a route or route segment, or modifications to a route. For another example, the routing information can be an image that depicts a route.

Semantic mapping information can generally refer to information that describes some aspect or characteristic of a route or mapping-related entity that is included in a map, such as a business entity, landmark, residence, POI, etc. Semantic mapping information may include textual content responsive to a query. For example, a model input can include a query related to a particular route, or an entity that is located on a map. Semantic mapping information can also include general descriptions of routes or entities located on a map. For example, the semantic mapping information may include a semantic description of a particular route (e.g., “this route is a scenic route along the coast that is unlikely to encounter any heavy traffic or adverse weather conditions”). For another example, the semantic mapping information can include a semantic description of a route segment with relation to a particular road or route segment (e.g., “the road on which this business is located is mostly frequented by business travelers during normal work hours”). For yet another example, the semantic mapping information can be, or otherwise include, a classification output that classifies certain routes or segments (e.g., traffic: low; collision probability; low; adverse weather probability; low, etc.).

In some implementations, for use-cases in which the machine-learned semantic routing model is utilized to predict route segments, or suggest alternate route segments, the computing system can limit such predictions or suggestions to known route segments that have been verified to exist. In other words, the model output can select a known route segment rather than attempting to generate a route segment that may or may not be traversable. In this manner, the computing system can ensure that route segments provided to users are traversable.

At 506, the computing system can provide the model output to the client computing device. A client computing device can generally refer to a device that receives routing or mapping-related services from the computing system, such as a user computing device (e.g., a smartphone, laptop, wearable device, etc.), a second computing system (e.g., a virtualized computing device, a compute or network node, etc.), etc. In some implementations, the computing system can provide the model output responsive to obtaining the model inputs. For example, the computing system can receive a routing or mapping-related request from the client computing device that includes the model inputs. In response, the computing system can provide the model outputs to the client computing device, or can provide information descriptive of the model outputs or otherwise based on the model outputs.

Additionally, or alternatively, in some implementations, the computing system can iteratively provide model outputs to client computing devices. For example, over a number of iterations the computing system can receive model inputs that include a request to classify a type of route segment associated with a particular route segment. After classifying a certain number of route segments, the computing system can update client computing devices by providing information indicative of the classified route segments. More generally, if the model output generated by the computing system is applicable to multiple client computing devices (e.g., classifying a route segment, classifying a business entity, etc.), the computing system can update some (or all) client devices based on the model output. For example, the computing system can push such information to the client devices by updating a mapping application associated with the computing system.

Additionally, or alternatively, in some implementations, the computing system can perform some other action with the model output. For example, if the model output classifies a certain route segment, or entity that exists within mapping data (e.g., a business, residence, landmark, POI, etc.), the computing system can store the classification to a data store that stores similar classifications to enable mapping services.

In some implementations, obtaining the one or more inputs for the machine-learned semantic routing model can include obtaining, from the client computing device, example route information indicative of one or more example routes and a second route that includes a plurality of second route segments, and a prompt indicative of a request to generate one or more alternate route segments for one or more respective second route segments of the second route based on the one or more example routes. Processing the one or more inputs to obtain the model output can include processing the example route information and the prompt to obtain the model output. The model output can include routing information indicative of the one or more alternate route segments for the one or more respective second route segments.

In some implementations, obtaining the one or more inputs for the machine-learned semantic routing model can include obtaining. from the client computing device, information indicative of a current route segment comprising an intermediate destination location. Processing the one or more inputs to obtain the model output can include processing the information indicative of the current route segment to obtain the model output. The model output can include one or more candidate route segments. A starting location of each of the one or more candidate route segments can correspond to the intermediate destination location of the current route segment.

In some implementations, obtaining the one or more inputs for the machine-learned semantic routing model can include obtaining, from the client computing device, (a) route request information descriptive of a route from a requested starting location to a requested destination location, and (b) preferred route characteristic information descriptive of a preferred route characteristic for the route. Processing the one or more inputs to obtain the model output can include processing the information indicative of the route request information and the preferred route characteristic information to obtain the model output. The model output can include information indicative of a route from the requested starting location to the requested destination location that includes the preferred route characteristic.

In some implementations, obtaining the one or more inputs for the machine-learned semantic routing model can include obtaining. from the client computing device, the information indicative of the one or more requested route segments. The information can include one or more images of one or more locations. Processing the one or more inputs to obtain the model output can include processing the information indicative of the current route segment to obtain the model output. The model output can include itinerary information indicative of a proposed route that includes at least one of the one or more locations.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
obtaining, by a computing system comprising one or more computing devices, training data comprising:
(a) route information indicative of a route from a starting location to a destination location, wherein the route comprises a plurality of route segments comprising a first subset of route segments and a second subset of route segments; and
(b) route characteristic information descriptive of one or more route characteristics;
processing, by the computing system, at least the first subset of route segments and a portion of the route characteristic information associated with the first subset of route segments with a machine-learned semantic routing model to obtain one or more predicted route segments for the second subset of route segments; and
adjusting, by the computing system, one or more parameters of the machine-learned semantic routing model based on an optimization function that evaluates a difference between the one or more predicted route segments and the second subset of route segments.

2. The computer-implemented method of claim 1, wherein processing the at least the first subset of route segments and the portion of the route characteristic information associated with the first subset of route segments with the machine-learned semantic routing model comprises:
processing, by the computing system, the at least the first subset of route segments and the portion of the route characteristic information associated with the first subset of route segments with a first portion of the machine-learned semantic routing model to obtain a latent representation of the first subset of route segments.

3. The computer-implemented method of claim 2, wherein the first portion of the machine-learned semantic routing model comprises an encoder and/or decoder portion of a pre-trained Large Language Model (LLM).

4. The computer-implemented method of claim 3, wherein the method further comprises:
processing, by the computing system, input data with the machine-learned semantic routing model to obtain a model output, wherein the input data comprises:
route information indicative of a second route from a second starting location to a second destination location; and
a prompt indicative of a request to describe the second route; and
wherein the model output comprises textual content descriptive of the second route.

5. The computer-implemented method of claim 3, wherein the method further comprises:
processing, by the computing system, input data with the machine-learned semantic routing model to obtain a model output, wherein the input data comprises textual content descriptive of a requested route, and wherein the model output comprises route information indicative of the requested route.

6. The computer-implemented method of claim 5, wherein, prior to processing the input data with the machine-learned semantic routing model to obtain the model output, the method comprises:
processing, by the computing system, second training data comprising a training route with the machine-learned semantic routing model to obtain a textual description of the training route; and
adjusting, by the computing system, one or more parameters of the machine-learned semantic routing model based on a loss function that evaluates the textual description of the training route and a corresponding ground-truth textual description of the training route.

7. The computer-implemented method of claim 2, wherein processing the at least the first subset of route segments and the portion of the route characteristic information associated with the first subset of route segments with the first portion of the machine-learned semantic routing model further comprises:
processing, by the computing system, the latent representation with a graph-based portion of the machine-learned semantic routing model to obtain a graph output, wherein the graph output comprises:
a plurality of nodes representative of the starting location, the destination location, and intermediate locations between the starting location and the destination location; and
a plurality of edges representative of a plurality of route segments.

8. The computer-implemented method of claim 1, wherein the method further comprises:
processing, by the computing system, input data with the machine-learned semantic routing model to obtain a model output, wherein the input data comprises:
route information indicative of a one or more first route segments of an incomplete route; and
a prompt indicative of a request to generate one or more second route segments with requested route characteristics for the incomplete route; and
wherein the model output comprises the one or more second route segments with the requested route characteristics.

9. The computer-implemented method of claim 1, wherein the method further comprises:
processing, by the computing system, input data with the machine-learned semantic routing model to obtain a model output, wherein the input data comprises:
route information indicative of one or more example routes and a second route comprising a plurality of second route segments; and
a prompt indicative of a request to generate one or more alternate route segments for one or more respective second route segments of the second route based on the one or more example routes; and
wherein the model output comprises the one or more alternate route segments of the second route.

10. The computer-implemented method of claim 1, wherein the method further comprises:
processing, by the computing system, input data with the machine-learned semantic routing model to obtain a model output, wherein the input data comprises route information descriptive of a second route comprising a plurality of second route segments, and wherein the model output comprises classification information that classifies the route as a first route type of a plurality of route types.

11. The computer-implemented method of claim 10, wherein the classification information further classifies a second route segment of the plurality of second route segments as a first route segment type of a plurality of route segment types.

12. The computer-implemented method of claim 1, wherein the method further comprises:
processing, by the computing system, input data with the machine-learned semantic routing model to obtain a model output, wherein the input data comprises a current route segment comprising an intermediate destination location for an existing route; and
wherein the model output comprises one or more candidate route segments, and wherein a starting location of each of the one or more candidate route segments corresponds to the intermediate destination location of the current route segment.

13. The computer-implemented method of claim 12, wherein the method further comprises:
processing, by the computing system, input data with the machine-learned semantic routing model to obtain a model output, wherein the input data comprises:
route request information descriptive of a route from a requested starting location to a requested destination location; and
preferred route characteristic information descriptive of a preferred route characteristic for the route; and
wherein the model output comprises route information indicative of a route from the requested starting location to the requested destination location that comprises the preferred route characteristic.

14. The computer-implemented method of claim 1, wherein the method further comprises:
processing, by the computing system, input data with the machine-learned semantic routing model to obtain a model output, wherein the input data comprises one or more images of one or more locations; and
wherein the model output comprises itinerary information indicative of a proposed route that includes at least one of the one or more locations.

15. A computing system, comprising:
one or more processor devices;
a memory, comprising:
a machine-learned semantic routing model, wherein the machine-learned semantic routing model is trained to process mapping information to generate a model output comprising suggested route segments and/or information associated with route segments;
one or more tangible, non-transitory computer readable media storing computer-readable instructions that when executed by one or more processors cause the one or more processors to perform operations, the operations comprising:
obtaining, from a client computing device, one or more inputs for the machine-learned semantic routing model, wherein the one or more inputs comprises at least one of:
request information indicative of a requested route segment and/or a request for mapping-related information; or
route characteristic information indicative of one or more route characteristics;
processing the one or more inputs to obtain a model output, wherein the model output comprises at least one of:
(a) routing information indicative of a route that comprises one or more suggested route segments; or
(b) semantic mapping information associated with the route; and
providing the model output to the client computing device.

16. The computing system of claim 15, wherein obtaining the one or more inputs for the machine-learned semantic routing model comprises:
obtaining, from the client computing device, example route information indicative of one or more example routes and a second route comprising a plurality of second route segments, and a prompt indicative of a request to generate one or more alternate route segments for one or more respective second route segments of the second route based on the one or more example routes; and
wherein processing the one or more inputs to obtain the model output comprises:
processing the example route information and the prompt to obtain the model output, wherein the model output comprises routing information indicative of the one or more alternate route segments for the one or more respective second route segments.

17. The computing system of claim 15, wherein obtaining the one or more inputs for the machine-learned semantic routing model comprises:
obtaining, from the client computing device, information indicative of a current route segment comprising an intermediate destination location; and
wherein processing the one or more inputs to obtain the model output comprises:
processing the information indicative of the current route segment to obtain the model output, wherein the model output comprises routing information indicative of one or more candidate route segments, and wherein a starting location of each of the one or more candidate route segments corresponds to the intermediate destination location of the current route segment.

18. The computing system of claim 15, wherein obtaining the one or more inputs for the machine-learned semantic routing model comprises:
obtaining, from the client computing device:
route request information descriptive of a route from a requested starting location to a requested destination location; and
preferred route characteristic information descriptive of a preferred route characteristic for the route; and
wherein processing the one or more inputs to obtain the model output comprises:
processing the information indicative of the route request information and the preferred route characteristic information to obtain the model output, wherein the model output comprises routing information indicative of a route from the requested starting location to the requested destination location that comprises the preferred route characteristic.

19. The computing system of claim 15, wherein obtaining the one or more inputs for the machine-learned semantic routing model comprises:
obtaining, from the client computing device, the information indicative of the requested route segment, wherein the information comprises one or more images of one or more locations; and
wherein processing the one or more inputs to obtain the model output comprises:
processing the one or more images of the one or more locations to obtain the model output, wherein the model output comprises routing information indicative of a proposed route that includes at least one of the one or more locations.

20. One or more tangible, non-transitory computer readable media storing computer-readable instructions that when executed by one or more processors cause the one or more processors to perform operations, the operations comprising:
obtaining training data comprising:
(a) route information indicative of a route from a starting location to a destination location, wherein the route comprises a plurality of route segments comprising a first subset of route segments and a second subset of route segments; and
(b) route characteristic information descriptive of one or more route characteristics;
processing at least the first subset of route segments and a portion of the route characteristic information associated with the first subset of route segments with a machine-learned semantic routing model to obtain one or more predicted route segments for the second subset of route segments; and
adjusting one or more parameters of the machine-learned semantic routing model based on an optimization function that evaluates a difference between the one or more predicted route segments and the second subset of route segments.
